(19) United States
(12) Patent Application Publication
(10) Pub. No.: US 2017/0075985 A1
(43) Pub. Date: Mar. 16, 2017

(54) QUERY TRANSFORMATION FOR NATURAL LANGUAGE QUERIES

(71) Applicant: Microsoft Technology Licensing, LLC, Redmond, WA (US)

(72) Inventors: Doran Chakraborty, San Jose, CA (US); Manish Malik, Cupertino, CA (US); Qifa Ke, Cupertino, CA (US); Miriam Rosenberg, Kirkland, WA (US); Xinghua Lou, Fremont, CA (US)

(73) Assignee: Microsoft Technology Licensing, LLC, Redmond, WA (US)

(21) Appl. No.: 14/856,139

(22) Filed: Sep. 16, 2015

(51) Int. Cl. G06F 17/30; G06F 17/27; G06F 17/22

(52) U.S. Cl. CPC G06F 17/30654; G06F 17/2282; G06F 17/278; G06F 17/30616; G06F 17/2725

(57) ABSTRACT

A natural language query may be transformed to a transformed natural language while keeping sufficient semantic meaning such that the query may be transformed. A natural language query may be received by a computing device and sent to a natural language transformation model for transformation. The transformation may use a variety of techniques including stop word removal, stop structure removal, noun phrase/entity detection, key concept detection, dependency filtering. The techniques may be sequenced.

### BACKGROUND

Computing devices are offering more ways for a user to interact with the computing device. As this occurs, users are expecting the computing device to be able to interpret more natural ways of communicating. For example, whereas once a user was expected to type in specific syntax that the computing device could interpret, the computing device is now expected to understand a user querying the computer in a more natural way, such as “open my resume,” or “how do I get to my next appointment.” Moreover, with the advent of voice recognition capability, users are beginning to expect a computing device to interpret conversational language, such as “I would like to open my newest resume.” Interpreting these natural language queries takes an increasing amount of computing resources. Thus, it remains desirable to increase computing efficiency when interpreting user's natural language queries.

It is with respect to these and other general considerations that aspects of the technology have been made. Also, although relatively specific problems have been discussed, it should be understood that the aspects of the technology presented should not be limited to solving the specific problems identified in the background.

### SUMMARY

The disclosure generally relates to systems and methods for processing natural language queries to aid in the resolution of the queries. Various techniques for transforming natural language queries are presented. Aspects of the technology include removing redundant, less useful parts of a natural language query while at the same time identifying more useful parts of the natural language query. Application of the technology may transform a complex query to a simpler query while maintaining sufficient semantic meaning of the natural language query to allow applications, such as a personal digital assistant or a search engine, to resolve the query.

In aspects of the technology, natural language queries may be received by a computing device and processed in order to transform the natural language query into a form that may be easier or more efficient to resolve. For example, a computing device may receive a natural language query such as “My friend would like to know when the next flight from Chicago to New York is.” In response, the technology described herein may identify that the relevant portions of the query are “next,” “flight” and “Chicago to New York.” In this way, the technology herein may be used to save computing resources in unnecessary processing of the terms “my friend would like to know.” For example, the computing device could perform an Internet search on “next flights from Chicago to New York” without having to search “my friend would like to know.” In turn, the time searching and delivering relevant results is less than would be if the computing devices were to search on the terms “my friend would like to know.” Furthermore, network resources are saved where these results are delivered over a network, such as the Internet.

Additional aspects of the technology relate to a computing device having multiple applications that can directly receive queries. For example, queries may be received by an Internet search engine application, a word processor, a spread sheet application, and the like. Additionally, a computing device may use an application, such as a digital assistant, to receive queries. In aspects, the digital assistant receives queries and resolves queries directly, by passing the query to the appropriate application, or by using some combination thereof.

Additionally, aspects of the technology include computing devices using various techniques to transform a query. For example, unnecessary words may be removed from a query (stop word removal), unnecessary ideas may be removed from a query (stop structure removal), identification of key noun phrases may occur (noun phrase/entity detection), identification of key concepts in a query may occur (key concept detection), and parsing a sentence to determine its semantic structure may occur (dependency filtering). Moreover, the computing device may perform these and other techniques in a specific order to improve efficiency without losing the relevant information from the query. Furthermore, one or more of the techniques may be performed multiple times on a single query.

This Summary is provided to introduce a selection of concepts in a transformed form that are further described below in the Detail Description section. This Summary is not intended to identify key features or essential features of the claimed subject matter.

### BRIEF DESCRIPTION OF THE DRAWINGS

Non-limiting and non-exhaustive examples are described with reference to the following Figures.

FIG. 1 illustrates a networked-computing environment for transforming user queries.

FIG. 2 illustrates an alternative environment for transforming user queries.

FIG. 3 illustrates a system for transforming user queries.

FIG. 4 illustrates an embodiment of a sequence for transforming user queries.

FIG. 5 illustrates a method for transforming user queries using an ordered technique.

FIG. 6 illustrates a method for transforming user queries based on the application receiving the query.

FIG. 7 illustrates a method for a client computing device to transform natural language queries.

FIG. 8 illustrates a method for removing stop words from a received natural language query.

FIG. 9 illustrates a method for removing stop structures from a received natural language query.

FIG. 10 illustrates a method for performing noun phrase/entity detection operation on a received natural language query.

FIG. 11 illustrates a method for performing key concept detection on a received natural language query.

FIG. 12 illustrates a method for dependency filtering on a received natural language query.

FIG. 13 illustrates an exemplary tablet computing device that may execute one or more aspects disclosed herein.

FIGS. 14A and 14B illustrate a mobile computing device 1400, for example, a mobile telephone, a smart phone, a personal data assistant, a tablet personal computer, a laptop computer, and the like, with which examples of the invention may be practiced.

FIG. 15 illustrates one example of the architecture of a system for providing an application that transforms user queries.

### DETAILED DESCRIPTION

Aspects of the current technology relate to systems, methods, and devices operable to transform queries, such as, for example, natural language (NL) queries. Computers will often receive a query (from user input, for example), which query will be directed at causing the computing device to take an action. Where the received query came from a user (directly or indirectly), the user has the intent for the computer to resolve the received query. For example, the computing device may receive the query “I would like to know all the restaurants near me.” In such a case, the user's likely intent would be for the computer device to identify all retail establishments that serve food within the proximate location of the user, and then display the results via a graphical user interface. Received queries may be statements, such as “Show me the route to Boston,” or questions, such as “How do I get to Boston from here?” Received queries may be in the form of natural and/or colloquial language. The received queries may be audio input, such as spoken language received via a microphone, or textual input, such as input received using an input device or via a graphical user interface.

The received query may be transformed prior to resolving the query. For example, when a query is received by an Internet search engine, the intent of the user is likely to search the Internet for the subject of the query. However, a user may have entered the query (via voice, touch, or gesture input) using natural language. One example is “my friend would like to know the route for the Boston Marathon.” In this case, the intent of the user when querying the computer is to “get the route for the Boston Marathon.” Thus, transforming the query to the relevant language reflecting the intent of the user will allow for a more efficient search. That is, rather than returning results related to one's friend, the search will return information related to the route for the Boston Marathon. In cases, the result of searching on the transformed query rather than the received query saves processing time and network resources as less relevant terms are not searched on and results related to those less relevant terms are not delivered over a network.

Transformation of the received query may occur using a variety of techniques. For example, transformation may occur through the removal of unnecessary words, ideas, and/or phrases, the identification of key nouns, the identification of key concepts, and/or the parsing of the sentence structure. Each of these techniques, as well as others, may be applied in a particular order. That is, the techniques may be sequenced. A sequence may include the application of each technique more than one time.

Transformation of the received query alters the received query. For example, the application of one or more of this technique may “simplify” a query such that less relevant words and phrases are removed. Transformation may also weight words of the received query, which weights may be used by one or more applications used to resolve the query. In one aspect, the words are weighted such that an Internet search engine provides search results that are more relevant to the weighted words. Other alterations of the query may occur.

A transformed query may be provided to an application for resolution of the query. In aspects of the technology, a user provides a query to a search engine, the search engine application sends the query to a transform engine for transformation, and the search engine processes the transformed query. Other applications may receive the transformed query. For example, a calendar application, a word processing document, and other applications may receive the transformed query.

The application used to resolve the query need not be the application that received the query. For example, a digital assistant may receive a query. The digital assistant may determine that the query relates to a meeting domain, such as the query “I want to set a meeting with Rachel tomorrow at 8 am.” The technologies described herein may be used to transform the query. The transformed query may then be sent to a calendar application for resolution of the query. Continuing with the previous example, the calendar application may resolve the transformed query by setting a calendar event for a meeting with Rachel.

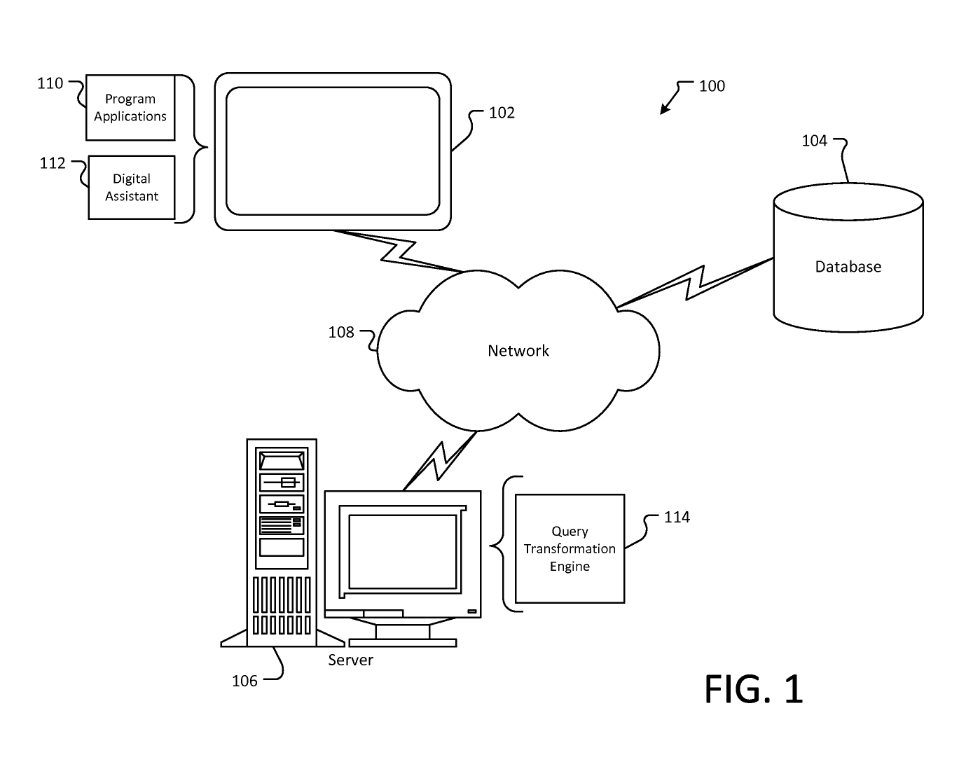

Turning now to FIG. 1, FIG. 1 illustrates a networked-computing environment 100 for transforming natural language queries. As illustrated, FIG. 1 includes a computing device 102, a networked-database 104, and a server 106, each of which is communicatively coupled to each other via a network 108.

The computing device 102 may be any suitable type of computing device. For example, the computing device 102 may be one of a desktop computer, a laptop computer, a tablet, a mobile telephone, a smart phone, a wearable computing device, or the like. Additionally, aspects of the current technology include the computing device storing one or more program applications 110 and storing a digital assistant 112.

Program applications 110 include software running on the computing device 102. The program applications include word processing software, spreadsheet applications, browsers, and the like. The program applications 110 may be complete applications, or they may be thin user-interfaces that communicate with a remote device, such as a server, to perform processing related to the program applications. Multiple program applications 110 may be stored on the computing device 102. Aspects of the technology include the program applications 110 having the ability to receive user queries, such as through text, touch, or speech input. For example, program applications 110 may be an Internet search engine and the user may enter query into the Internet search engine through speech.

The program applications 110 may be capable of resolving the received query. For example, where a program application is an Internet browser, the received query may be sent to a server for a search (such as a keyword search).

In aspects of the technology, program applications 110 first send the received query to a query transformation engine 114 prior to resolving the query. For example, the program applications 110 may receive a natural language query and send the received query to a query transformation engine 114 via a network 108. In aspects, program applications 110 may determine to send the received query to the query transformation engine 114 based on the type of input that was received. For example, where voice recognition software was used, the program applications 110 may automatically send the query to the received query transformation engine 114 for further processing. This may occur because input received from voice recognition software may be more likely to contain less relevant information. In other aspects, the type of program application is used in determining whether the received query is sent to the transformation engine 114 for transformation. For example, an Internet browser may always send the received query to the query transformation engine 114 for transformation. In additional aspects, the length of the received query determines whether the query is sent to the query transformation engine 114. A combination of features of the received query, the type of application, the traits of the user, and/or other features may be used to determine whether the received query is sent to the query transformation engine 114.

Additionally, aspects of the technology include a digital assistant 112 being located on a computing device 102. The digital assistant 112 may receive queries via an interface, such as a microphone, a graphical user interface, via a network, etc. The received query is interpreted, and, in response, the appropriate action is performed. For example, the digital assistant 112 may respond to requests or questions from a user of a computing device 102. Such requests or questions may be entered into the computing device 102 in a variety of ways including text, voice, gesture, and/or touch. The digital assistant 112 may interpret the query and resolve the query itself In aspects, the digital assistant 112 sends the input to another application (located on the computing device 102 and/or another computing device such as the server 106).

Further, the digital assistant 112 may first send a query to a query transformation engine 114 prior to resolving the query. For example, the a digital assistant 112 may receive a natural language query and send the natural language query to a query transformation engine 114 via a network 108. In aspects, the digital assistant 112 may determine to send the received query to a query transformation engine 114 based on the type of input that was received. For example, upon receiving audio input, the digital assistant 112 may automatically send the received query to the query transformation engine 114 for further processing. In other examples, the digital assistant may analyze the received query to determine whether it is a natural language query. If the received query is a natural language query, the query may be sent to the query transformation engine 114. In still further examples, all queries may be sent to the query transformation engine 114 regardless of the form that the query was received in. A combination of features of the received query, the type of application, the traits of the user, and/or other features may be used to determine whether the received query is sent to the query transformation engine 114.

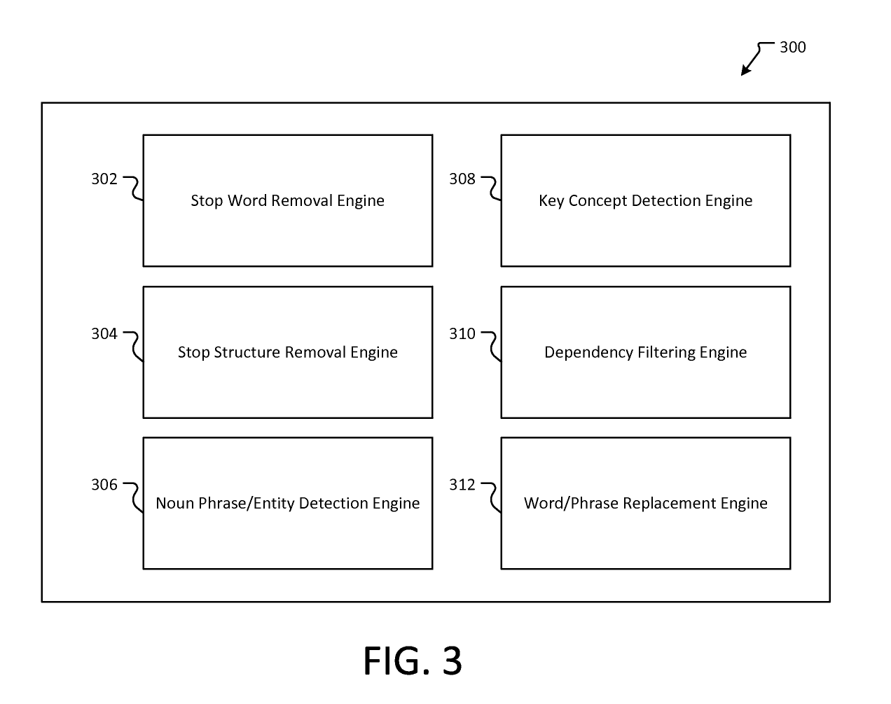

As illustrated, the query transformation engine 114 may reside on a remote device, such as server 106. In other examples, however, the query transformation engine may reside on computing device 102. The query transformation engine 114 receives queries from computing devices such as computing device 102. The query transformation engine 114 receives a query and transforms the query into a form that can be easily or more efficiently processed. For example, the query transformation engine 114 may receive a natural language query such as “how do I get to Boston from New York.” The query transformation engine 114 may transform this to “get to Boston from New York.” The query transformation model 114 may then send the transformed query to the computing device, software engine, and/or application from which the query came (such as program applications 110 or digital assistant 112). The query transformation engine 114 may use various techniques to transform queries. These techniques are discussed in further detail with respect to FIG. 3.

System 100 may also include a database 104. The database 104 may be used to store a variety of information including information used to perform one or more techniques associated with transforming natural language queries. For example, dictionaries used to store words and phrases that may be removed from certain received queries, rules used to transform received queries, and other libraries may be stored in database 104.

Network 108 facilitates communication between devices, such as computing device 102, database 104, and server 106. The network 108 may include the Internet and/or any other type of local or wide area networks. Communication between devices allows for the exchange of natural language queries as well as transformed natural language queries.

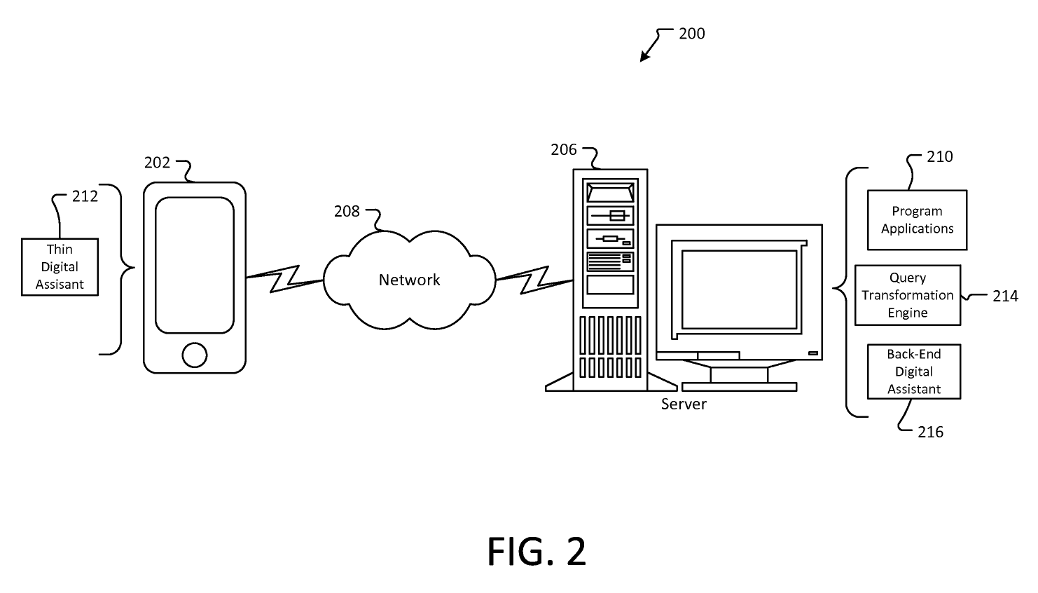

FIG. 2 illustrates an alternative environment 200 for transforming user queries. As illustrated, the networked environment 208 includes a computing device 202 and a server 206, each of which is communicatively coupled to each other via a network 208. It will be appreciated that the elements of FIG. 2 having the same or similar names as those of FIG. 1 have the same or similar properties.

As illustrated, a thin digital assistant 212 is stored on a computing device 202. The thin digital assistant 212 is configured to display audio and visual messages and receive input (such as natural language queries). The input may be sent via a network 208 to a server 206, and some or all of the processing of received requests is completed by the back end digital assistant 216. Further the back end digital assistant 216 works with the thin digital assistant 212 to provide the same or similar user experience as the digital assistant described with reference to FIG. 1.

Additionally, the networked system includes a server 206 hosting the program applications 210 and the query transformation engine 214. The program applications 210 may resolve queries that are received by the computing device 202. While FIG. 1 and FIG. 2 illustrate systems in a particular configuration, it will be appreciated that a query transformation model, a digital assistant, and program applications may be distributed in a computing device in a variety of ways to facilitate the transformation of natural language queries.

FIG. 3 illustrates a system for transforming user queries. In aspects, system 300 includes a stop word removal engine 302, a stop structure removal engine 304, a noun/phrase entity detection engine 306, a key concept detection engine 308, and a dependency filtering engine 310. The components described in FIG. 3 may be implemented in hardware, software, or a combination of hardware and software.

For example, unnecessary words may be removed from a query using the stop word removal engine 302. Unnecessary words may be identified using a variety of techniques. For example, a catalog of words may accessed by a stop word removal engine 302 when a natural language query is being analyzed by the stop word removal engine 302. For example, articles, pronouns, and/or specific words may have insufficient semantic meaning to be useful when resolving the query. Additionally, the catalog of words may change depending where the query originated from. For example, a user may have queried a word document with the query “replace every instance of ‘the cat’ with ‘my dog.’” In such a case, the articles “the” and “my” would be very important in resolving the query. On the other hand, if a user queried a search engine with “can my dog eat chocolate,” the query may be resolved without the need for the word “my.”’ As such, the stop word removal engine 302 may accesses different catalogs of stop words after identifying the origin of the query.

Additionally, system 300 includes stop structure removal engine 304. A stop structure is a series of two or more words (i.e., all or a portion of the sentence structure) that has been identified to have insufficient semantic meaning to be kept in a query. In aspects of the technology, stop structure removal engine removes unnecessary phrases or portions of a sentence. Unnecessary phrases may be identified by semantic meaning. For example, parts of a query that relate to the user's intent in asking the query such as “my friend wants to know” or “I was just wondering” may have little value in resolving a query. As such, stop structure removal engine 304 may remove these portions of the query prior to passing the query to either another engine in system 300 or to a program application to resolve the query

Further, certain syntactic structures may be identified as adding insufficient semantic meaning to sufficiently aid in resolving the queries. Such syntactic structures may include the syntax “I want to,” “Can you,” “How do I,” or similar structures. For example, in each of the queries “I want to get directions from Boston to New York,” “I want to learn how to play guitar,” “I want to call my mother” the structure “I want to” may be removed without substantially diminishing the ability to resolve the query.

The phrases or ideas that may be removed by the stop structure removal engine 304 may change based on the source of the query. For example, the phrase “I want” may be removed for Internet search engines, but the phrase “I want” may carry significant semantic meaning when entered into other applications such that the removal of the idea would change the semantic intent of the user query. For example, a user may provide a music player with the natural language “Let's hear I want you to want me by Cheap Trick.” In such a case, the phrase “I want” aids in resolving the query.

System 300 also includes noun phrase/entity detection engine 306. The noun phrase/entity detection engine 306 identifies key noun phrases and entities by analyzing and tagging the functions of words in a sentence. In aspects, a chunker/tagger system is used. For example, a query may be “What TV channel is showing live high school football in Ohio today?” The noun phrase/entity detection model 306 may identify the following words as entities that are related: “TV channel” and “high school football.” In aspects, noun phrase/entity detection engine 306 may tag identified entities. The tagging of these words may prevent other engines, such as stop word removal engine 302, from removing a word in the identified entity. In aspects, tagged entities are provided a weight, which weight may be passed to a program application, such as a search engine application. The weighted entities may then be emphasized in the search. For example, a search may rank results with “high school” connected higher than results with “high” and “school” not connected.

Additionally, system 300 may also include key concept detection engine 308. Key concept detection engine 308 may perform key concept detection. In key concept detection, key concepts are identified. Key concepts may be phrases that are well known in a language such as “to be or not to be.” In aspects, engine 308 tags key concepts so as not to be affected by other engines, such as stop word removal 302.

System 300 also includes a dependency filtering engine 310. The dependency filtering engine parses a sentence to determine its semantic structure. The dependency filtering engine 310 acts on a natural language query to enable a better semantic understanding of the query. Specifically, the dependency filtering engine 310 may identify relationships between words in a query (such as adjective, modifiers, preposition, noun, etc.). In aspects, this may allow the system 300 to identify directional relationships between words. For, example, if received query were to include the phrase “directions from New York to Boston” the dependency filter could identify that there is a directional relationship between Boston and New York. The system may tag this directional relationship in order to preserve this relationship to ensure that a stop word engine, such as a stop word engine 302.

System 300 also includes a word/phrase replacement engine 312. Word/phrase replacement engine 312 analyses the words of a natural language query to determine whether one or more words may be replaced. For example, if the word is “today,” the word/phrase replacement engine 312 may replace the word “today” with the date that the query was presented (for example Thursday, Sep. 10, 2015). Additionally, phrases may be identified and replaced. For example, if the natural language query included the phrase “when did the president of the United States take office,” then the word/phrase replacement engine 312 may replace “the president of the United States” with the current president. A library of potential words/phrases to be replaced may be stored. For example, words such as “here,” “today,” “America” may be indexed to a user's current location, the current date, and “the United States of America” in a library such that the use of the words “here,” “today,” and “America” may be replaced.

System 300 may perform one or more of these techniques in any order. Further system 300 may apply one or more of these techniques in a certain sequence. For example, the computing device may perform these and other techniques in a specific order to improve efficiency without losing the relevant information from the query. Furthermore, one or more of the techniques may be performed multiple times on a single query.

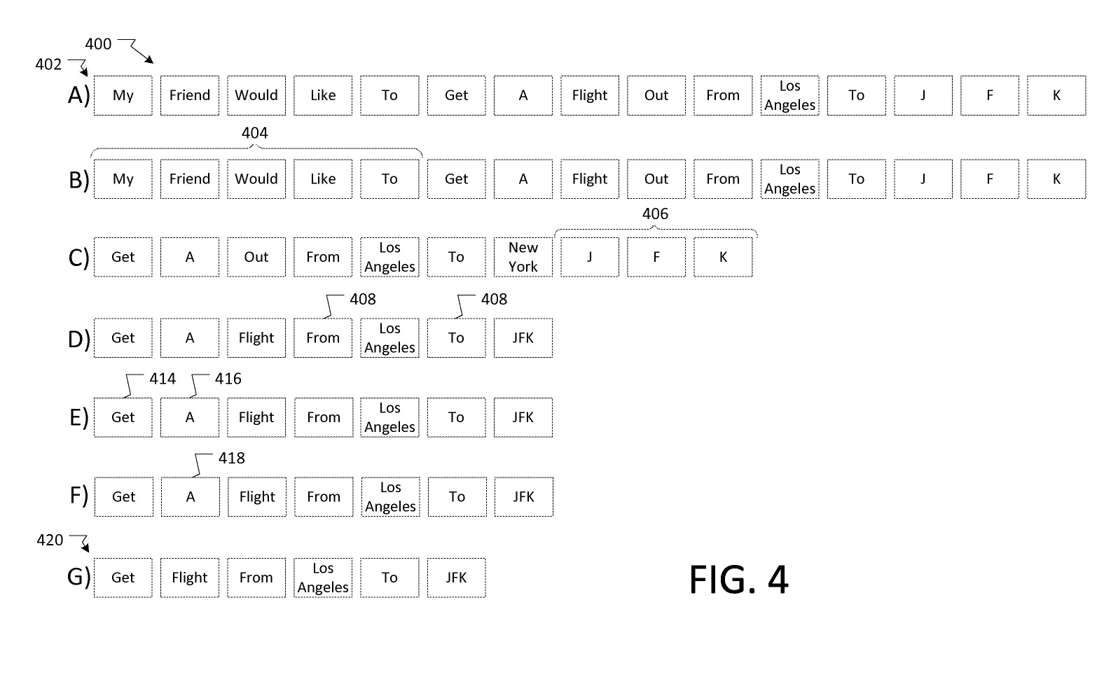

FIG. 4 illustrates an embodiment of a sequence 400 for transforming received queries. As illustrated sequence 400 begins with the received natural language query 402 “My friend would like to get a flight out from Los Angeles to JFK,” which is received in step A. The query may be received from a remote or local computing device. The received query may have been input into an Internet search engine or a digital assistant.

From there, the sequence 400 continues to step B. At step B, a stop structure removal operation is applied, which may be applied by a stop structure engine such as stop structure engine 304. The stop structure removal operation may iterate through each potential phrase in the natural language query. Alternatively, groups of 3, 4, and 5 words may be analyzed to determine if any phrase within the natural language query contains a structure that does not have sufficient relevance when resolving the query. Any number of words may be analyzed. In this example, it is identified that the phrase 404 “My friend would like to” is not sufficiently relevant to resolving the query. This may be determined by identifying the syntactic structure of the phrase or by identifying the semantic meaning of the phrase. A library of stop structures may be used to compare whether a group of words in a received query are stop structures.

At step C, key concept detection is applied. Key concept detection may be applied by an engine such as key concept detection engine 308. The key concept detection operation of step C identifies key terms. Key terms may be identified by comparing one or more words from the received query 402 to a library. Here, the key concept detection was used to identify the term 406 “JFK” as a key concept. In this example the term “JFK” was identified as a key concept. This key concept may be given a greater weight when the transformed query is passed to an application, such as an Internet search application.

From there sequence 400 proceeds to step D. At step D, dependency filtering occurs. Dependency filtering may be applied by an engine such as dependency filtering engine 310. In dependency filtering the directional relationship of words may be identified. For example, it may be determined that the phrase “from Los Angeles to JFK” has a direction. As such, the direction words 408 (e.g., to and from) may be tagged such that the words are not removed by further processes.

From there sequence 400 proceeds to step E. At Step E, noun phrase/entity detection occurs. Noun phrase/entity detection identifies the function of the words in the sentence. At step D, an engine, such as noun phrase/entity detection engine 306 may determine what functions words have. For example, it may be determined that the word “get” is a verb 414, the word “a” is an article 416, etc.

The sequence 400 proceeds to Step F, which is a stop word removal step. Stop word removal may be applied by an engine such as stop word removal engine 302. In aspects, words such as articles 418 are removed. Stop words may be identified using a library of stop words. In Sequence E, words such as to and from that may have been tagged may be ignored even if the words were in the library.

At sequence step G, the received query has been transformed to transformed query 420. The transformed query 420 may then be sent back to the computing device or other system for resolution of the query.

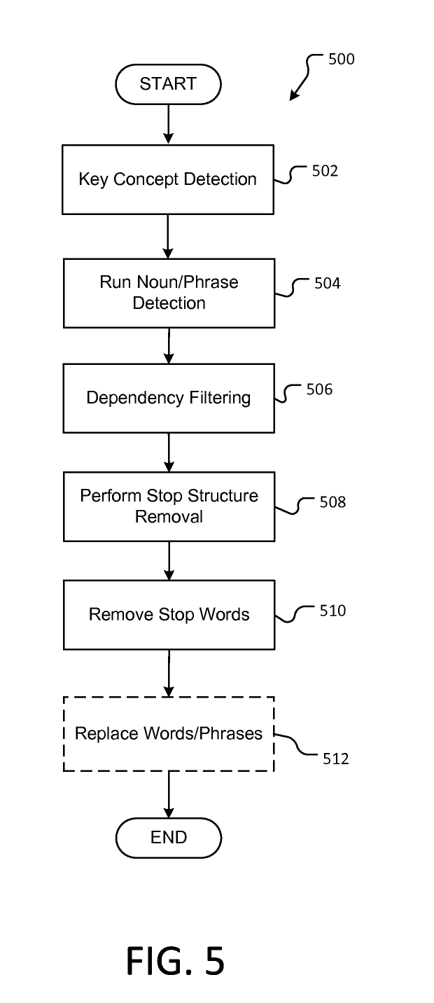

FIG. 5 illustrates a method 500 for transforming user queries using an ordered technique. Method 500 begins with key concept detection operation 502. In key concept detection operation 502, potential phrases are checked to determine if the phrases in a natural language query are a key concept. In aspects, two, three, and four word phrases from the natural language query are analyzed. Any number of words may be analyzed. In aspects, a comparison to a library of key concepts may be used. In aspects, the key concepts may be assigned a search weight. This may facilitate the resolution of the query where the resolution involves using an Internet search engine.

At operation 504, a noun/phrase entity detection may be performed. In noun/phrase entity detection, the function of words in the natural language query may be identified. Words with certain functions (such as proper noun) may be assigned a weight for use with a search engine.

Method 500 proceeds to operation 506 where dependency filtering occurs. In dependency filtering, the relationship between words within a natural language query is analyzed. This may occur to identify directional relationships. For example, where a received query is “how many pounds in a ton” the dependency filter may identify that there is a directional relationship of the phrase.

At operation 508, stop structures are removed. Stop structures may be phrases and/or concepts that do not add in resolving the query. This may include phrases that are directed at the intent of the user asking the query pleasantries and the like.

Method 500 proceeds to remove stop word operation 510. Stop words relate to words that may be removed without sufficiently altering the semantic meaning of the natural language query. For example, articles, prepositions, conjunctions, etc. may be removed.

Method 500 then optionally proceeds to replace words/phrases operation 512. In operation 512 one or more words of the natural language query are compared with a library of words/phrases to identify words that may be replaced. For example, if the word is “today,” operation 512 may replace the word “today” with the date that the query was presented (for example Thursday Sep. 10, 2015) based on the word “today” being in the library.

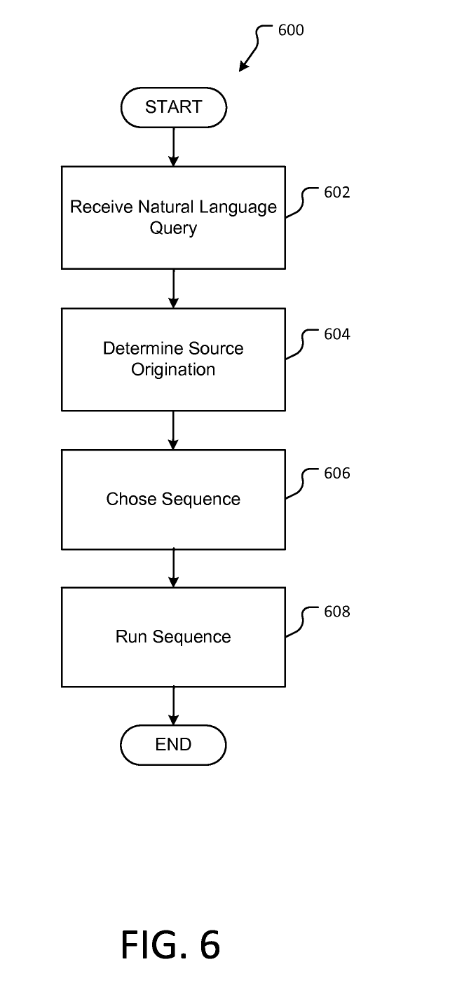

FIG. 6 illustrates a method 600 for transforming user queries based on the application receiving the query. Method 600 begins with operation receive natural language query operation 602. In operation 602, a natural language query is received. The natural language query may originate from a computing device hosting software applications and/or digital assistant. The natural language query may be sent over a network and may be received by a natural language transformation model.

At operation 604, the method proceeds to determine source origination. At operation 604, the source origination is determined For example, it may be determined that the origination of the natural language query is a user entering a query into an Internet search engine. In some cases, the natural language query may originate by a user entering a voice command to a digital assistant. Still in others, the natural language query may originate by a user entering text into a word processor help tool. The source origination of the natural language query is the application that received the natural language query. This information may include the software application and/or digital assistant that received the natural language query, the version of the software application and/or digital assistant, and/or the computing device where the natural language query was first received.

Method 600 then proceeds to operation 606 where a sequence is chosen. In aspects, the sequence is chosen based on the originating source of the natural language query. In additional aspects, a sequence is chosen irrespective of where the natural language query originated. In one aspect of the technology, the following sequence is chosen: key concept detection, dependency filtering, stop structure removal, stop word removal, and noun phrase detection. In further aspects, the sequence is different.

Method 600 proceeds to operation 608 where the sequence may be performed on the natural language query. In operation 608, the sequence of techniques chosen in operation 606 is applied to the natural language query. The result is the production of a transformed natural language query.

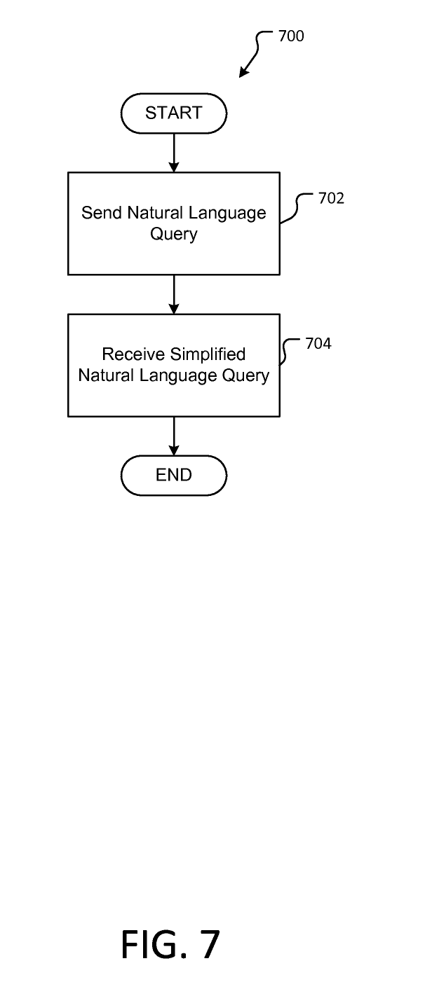

FIG. 7 illustrates a method for a client computing device to transform natural language queries. Method 700 begins with receive user query operation 702. In operation 702, a computing device receives a natural language query from a user, either directly or indirectly. For example, a user may have entered a search into an Internet search engine using a natural language query.

Method 700 then proceeds to send natural language query operation 704. In operation 704, a natural query may be sent to a natural language transformation model for transformation. The natural language transformation model may be on the same computing device where the natural language query was received. Additionally, the natural language transformation model may be on a server connected to the computing device via a network, such as the Internet.

Method 700 proceeds to receive transformed natural language query operation 704. In operation 704, a transformed natural language query is received. The received transformed natural language query may have sufficient semantic meaning such that the query may be appropriately resolved.

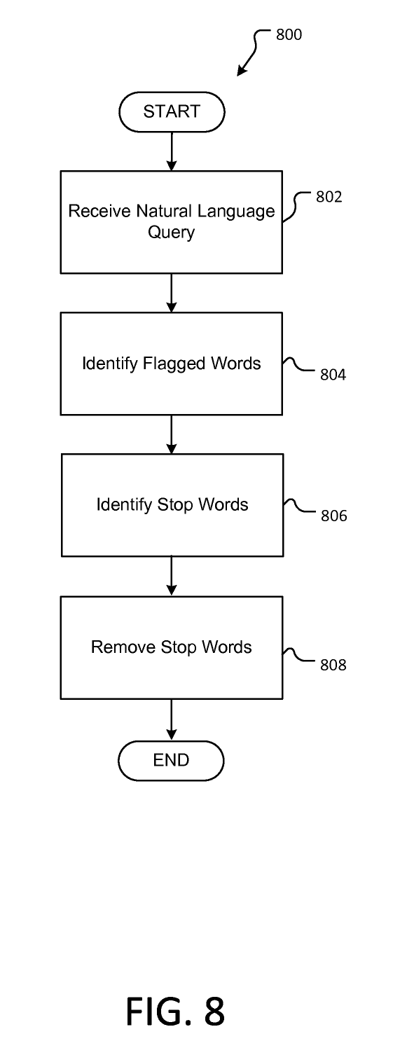

FIG. 8 is a method 800 for removing stop words from a received natural language query. Method 800 beings with receive natural language query operation 802. In receive natural language query 802, a natural language query is received. A natural language query may be entered into a computing system by a user. This may occur via voice, gesture, text, or other means. The received natural language query may be sent via a network to a stop word removal engine, such as stop word removal engine 302. In aspects, the received natural language query is sent from another engine, such as key concept detection engine 308.

Method 800 then proceeds to identify tagged words operation 804. In identify tagged words operation 804, tagged words are identified from the received natural language query. For example, a natural language query may be “How do I get to New York from Chicago.” The portion of the natural language query “to New York from Chicago” may have been tagged. This may have occurred manually, or by a key concept detection engine, such as key concept detection engine 308.

Method 800 then proceeds to identify stop words 806. In operation 806, some or all of the words of the received natural language query are analyzed to determine whether the word is a stop word. For example, each word of the received natural language query may be compared to a database of words (e.g., a library of words). The database of words may include words that are candidates to be removed from the natural language query such that the remaining words of the natural language query are sufficient to be resolved.

For example, where the natural language query was entered into an Internet browser, it may be identified that words such as articles and/or prepositions may be removed from the natural language query while still maintaining a high relevancy result rate when performing an Internet search on the natural language query with the removed articles. Other words may be removed. The words that may be removed may be determined by experimental data or other means.

In aspects of the technology, portions of the natural language query that were identified as tagged words in operation 804 are not identified as stop words irrespective of whether the words would otherwise be stop words. For example, prepositions such as to and from may not be identified in the phrase “to New York from Chicago” where the phrase was flagged as a key concept.

Method 800 then proceeds to remove stop word operation 808. In operation 808 words identified as stop words in operation 806 are removed. The resulting query is an example of transformed query.

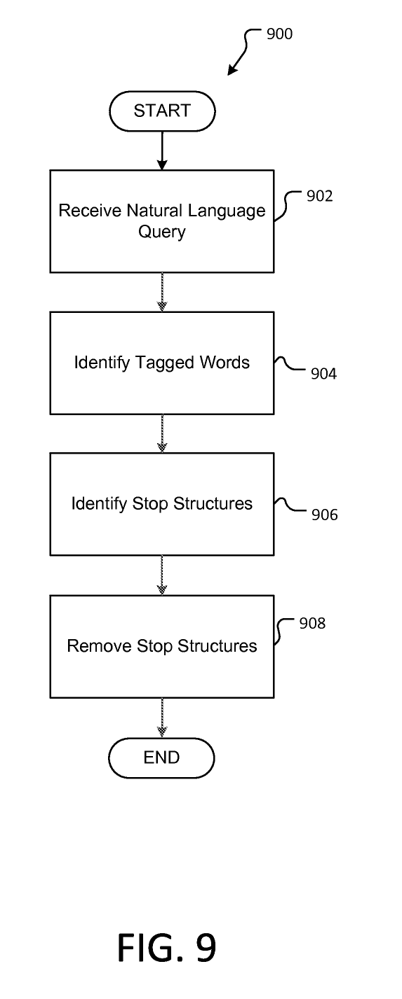

FIG. 9 is a method for removing stop structures from a received natural language query. Method 900 begins with receive natural language query operation 902. In receive natural language query 902, a natural language query is received. A natural language query may be entered into a computing system by a user. This may occur via voice, gesture, text, or other means. The natural language query may be sent via a network to a stop structure removal engine, such as stop structure removal engine 304. In aspects, the received natural language query is sent from another engine, such as key concept detection engine 308 or other engine.

Method 900 then proceeds to identify tagged words operation 904. In identify tagged words operation 904, tagged words are identified from the received natural language query. For example, a natural language query may be “How do I get to New York from Chicago.” The portion of the natural language query “to New York from Chicago” may have been tagged as an important concept. This may have occurred manually, or by a key concept engine, such as key concept engine 308.

Method 900 then proceeds to identify stop structures 906. In operation 906, the received natural language query may be analyzed to determine whether the structure is a stop structure. For example, two, three, or four word groups of a natural language query may be may be compared to a database of words (e.g., a library of words). The database of words may include structures that are candidates to be removed from the natural language query such that the remaining words of the natural language query are sufficient to be resolved.

For example, where the natural language query was entered into an interest search browser, it may be identified that structures that are “I want” may be removed from the natural language query while still maintaining a high relevancy rate when performing an Internet search on the natural language query with the removed articles. Other structures may be removed. The structures that may be removed may be determined by experimental data or other means.

In aspects of the technology, portions of the natural language query that were identified as tagged words in operation 904 are not identified as stop structures. For example, the phrase “to New York from Chicago” may be prevented from being identified as a stop structure where the phrase was flagged as a key concept.

Method 900 then proceeds to remove stop structure operation 908. In operation 908 structures identified as stop structures in operation 906 are removed. The resulting query is an example of transformed query.

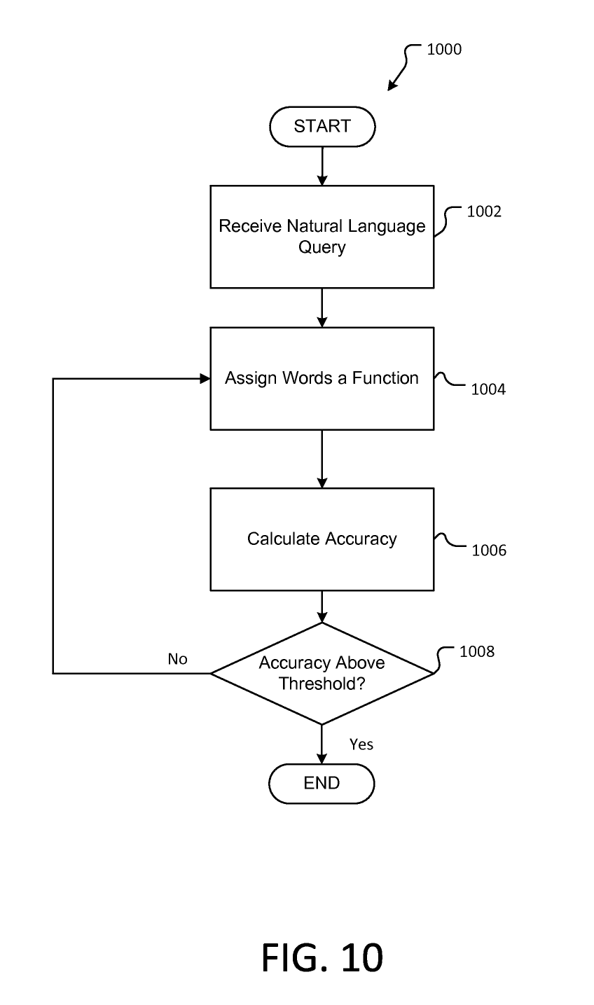

FIG. 10 is a method for performing noun phrase/entity detection operation 1000 on a received natural language query. Method 1000 beings with receive natural language query operation 1002. In receive natural language query 1002, a natural language query is received. A natural language query may be entered into a computing system by a user. This may occur via voice, gesture, text, or other means. The natural language query may be sent via a network to noun phrase entity detection engine, such as noun phrase entity detection engine 306. In aspects, the received natural language query is sent from another engine, such as key concept detection engine 308.

The method continues to assign one or more words a function operation 1004. In operation 1004, words in a sentence may be assigned the function of a noun, a verb, an article, etc. This may be done randomly. In aspects, a library of preexisting words most likely function is used.

From there the method 1000 proceeds to calculate accuracy 1006. The likelihood that the words in the sentence have accurately been assigned is calculated. This may be done by analyzing whether the sentence follows a typical sentence structure (e.g., noun verb preposition noun). Typical sentence structures may be in a library.

At determine operation 1008, if the accuracy is above some predetermined threshold, then the method ends. If not, the method returns to operation 1004 where one or more words are reassigned a function.

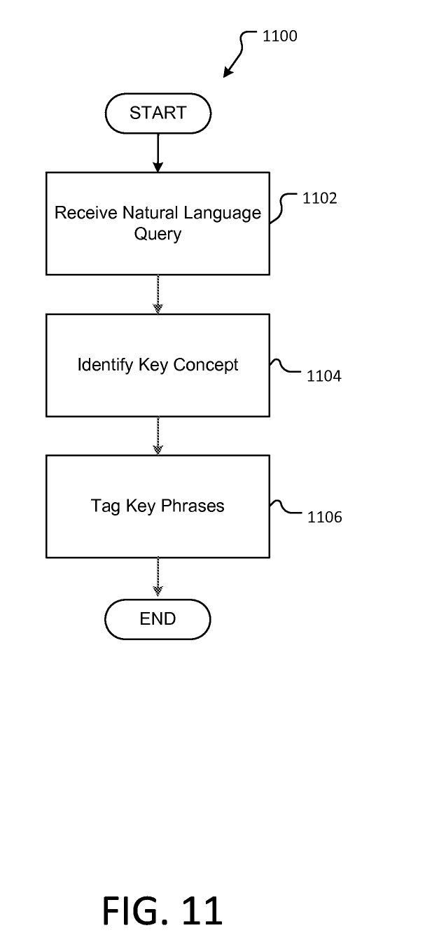

FIG. 11 is a method 1100 for performing key concept operation 1100 on a received natural language query. Method 1100 beings with receive natural language query operation 1102. In receive natural language query 1102, a natural language query is received. A natural language query may be entered into a computing system by a user. This may occur via voice, gesture, text, or other means. The natural language query may be sent via a network to noun phrase entity detection engine, such as noun phrase entity detection engine 306. In aspects, the received natural language query is sent from another engine, such as dependency filtering engine 310.

Method 1100 then proceeds to identify key concepts operation 1104. Key concepts may be identified by analyzing a library. Key concepts include phrases that are well known such as “to be or not to be,” “the civil war,” and “the world wide web.”

Method 1100 then proceeds to tag key concepts operation 1106. In operation 1106, key concepts are tagged. Tagging may include assigning a weight to the key concept such that if the query is sent to an application, such as an Internet search engine application, the returned search results will emphasize the key concept.

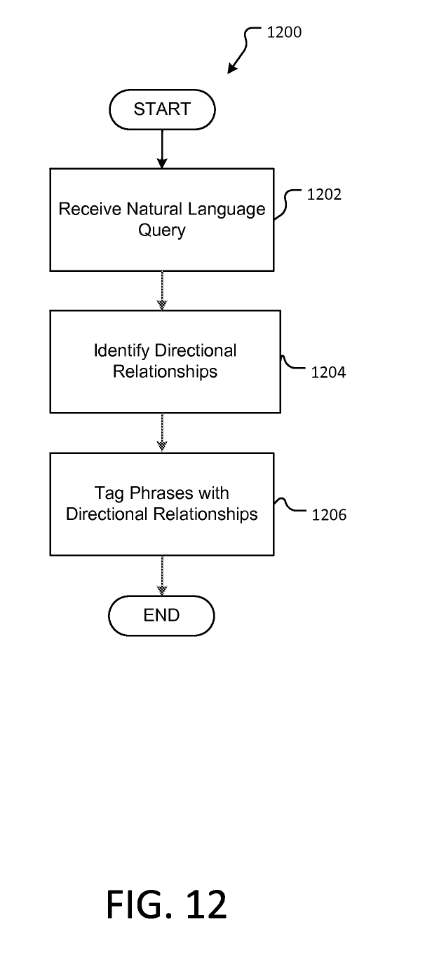

FIG. 12 is a method 1200 for dependency filtering on a received natural language query. Method 1200 begins with receive natural language query operation 1202. In receive natural language query 1202, a natural language query is received. A natural language query may be entered into a computing system by a user. This may occur via voice, gesture, text, or other means. The natural language query may be sent via a network to noun phrase entity detection engine, such as noun phrase entity detection engine 306. In aspects, the received natural language query is sent from another engine, such as stop structure removal engine 304.

Method 1200 then proceeds to identify directional relationships 1204. This may be accomplished by using a standard dependency parser such as Stanford NPL parser or Microsoft® research parser. In operation 1204 one or more words of a received query may be provided to a parser to identify phrases that have directional relationships.

Method 1200 then proceeds to tag phrases with directional relationships operation 1206. In operation 1206, key concepts are tagged. Tagging may include assigning a weight to the directional phrase such that when the query is sent to an application, such as an Internet search engine application, the returned search results will emphasize the directional relationship.

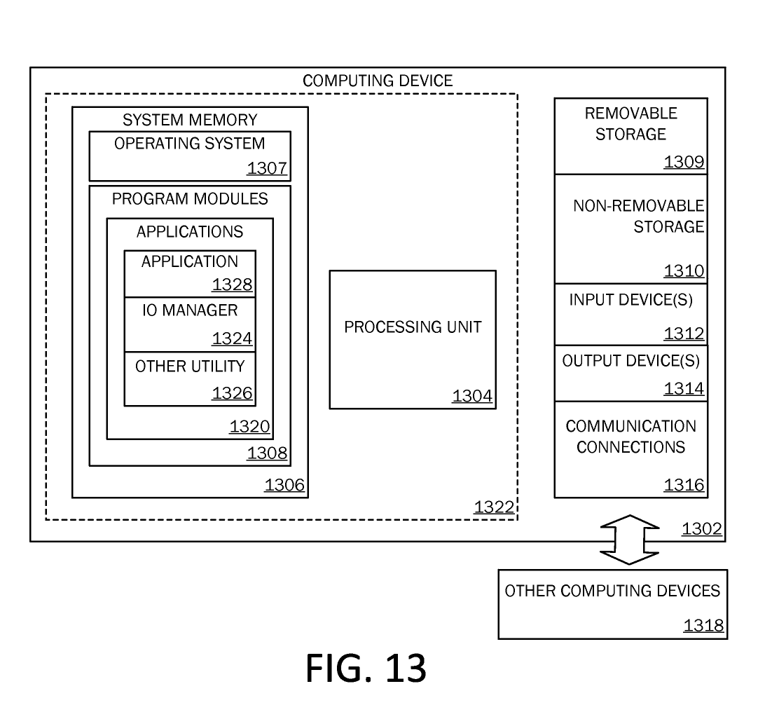

FIGS. 13-15 and the associated descriptions provide a discussion of a variety of operating environments in which examples of the invention may be practiced. However, the devices and systems illustrated and discussed with respect to FIGS. 13-15 are for purposes of example and illustration and are not limiting of a vast number of computing device configurations that may be utilized for practicing examples of the invention, described herein.

FIG. 13 is a block diagram illustrating physical components of a computing device 1302, for example a component of a system with which examples of the present disclosure may be practiced. The computing device components described below may be suitable for the computing devices described above. In a basic configuration, the computing device 1302 may include at least one processing unit 1304 and a system memory 1306. Depending on the configuration and type of computing device, the system memory 806 may comprise, but is not limited to, volatile storage (e.g., random access memory), non-volatile storage (e.g., read-only memory), flash memory, or any combination of such memories. The system memory 1306 may include an operating system 1307 and one or more program modules 1308 suitable for running software applications 1320 such as application 1328, IO manager 1324, and other utility 1326. As examples, system memory 1306 may store instructions for execution. Other examples of system memory 1306 may have components such as a knowledge resource or learned program pool, as examples. The operating system 1307, for example, may be suitable for controlling the operation of the computing device 1302. Furthermore, examples of the invention may be practiced in conjunction with a graphics library, other operating systems, or any other application program and is not limited to any particular application or system. This basic configuration is illustrated in FIG. 12 by those components within a dashed line 1322. The computing device 1302 may have additional features or functionality. For example, the computing device 1302 may also include additional data storage devices (removable and/or non-removable) such as, for example, magnetic disks, optical disks, or tape. Such additional storage is illustrated in FIG. 13 by a removable storage device 1309 and a non-removable storage device 1310.

As stated above, a number of program engines and data files may be stored in the system memory 1306. While executing on the processing unit 1304, the program modules 1308 (e.g., application 1328, Input/Output (I/O) manager 1324, and other utility 1326) may perform processes including, but not limited to, one or more of the stages of the operational method 500, 600, and 700 illustrated in FIGS. 5, 6, and 7. Other program engines that may be used in accordance with examples of the present invention may include electronic mail and contacts applications, word processing applications, spreadsheet applications, database applications, slide presentation applications, input recognition applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 13 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 1302 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 1302 may also have one or more input device(s) 1312 such as a keyboard, a mouse, a pen, a sound input device, a device for voice input/recognition, a touch input device, etc. The output device(s) 1314 such as a display, speakers, a printer, etc. may also be included. The aforementioned devices are examples and others may be used. The computing device 1302 may include one or more communication connections 1316 allowing communications with other computing devices 1318. Examples of suitable communication connections 1316 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program engines. The system memory 1306, the removable storage device 1309, and the non-removable storage device 1310 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1302. Any such computer storage media may be part of the computing device 1302. Computer storage media does not include a carrier wave or other propagated or modulated data signal.

Communication media may be embodied by computer readable instructions, data structures, program engines, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, RF, infrared, and other wireless media.

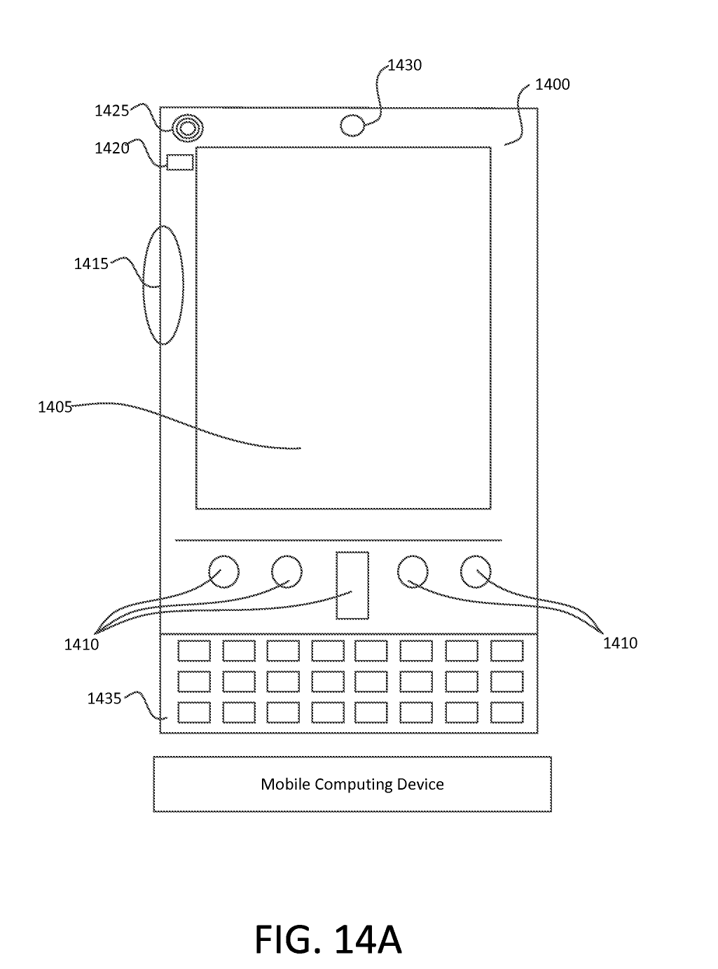

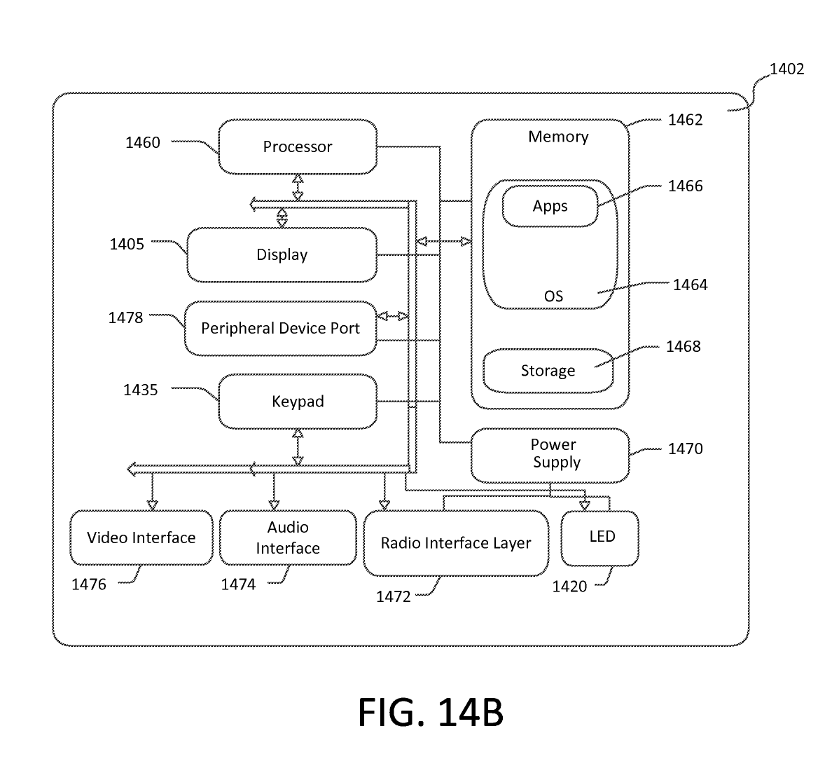

FIGS. 14A and 14B illustrate a mobile computing device 1400, for example, a mobile telephone, a smart phone, a personal data assistant, a tablet personal computer, a laptop computer, and the like, with which examples of the invention may be practiced. For example, mobile computing device 1400 may be implemented as system 100, components of systems 100 may be configured to execute processing methods as described in FIGS. 5, 6, and/or 7, among other examples. With reference to FIG. 14A, one example of a mobile computing device 1400 for implementing the examples is illustrated. In a basic configuration, the mobile computing device 1400 is a handheld computer having both input elements and output elements. The mobile computing device 1400 typically includes a display 1405 and one or more input buttons 1410 that allow the user to enter information into the mobile computing device 1400. The display 1405 of the mobile computing device 1400 may also function as an input device (e.g., a touch screen display). If included, an optional side input element 1415 allows further user input. The side input element 1415 may be a rotary switch, a button, or any other type of manual input element. In alternative examples, mobile computing device 1400 may incorporate more or less input elements. For example, the display 1405 may not be a touch screen in some examples. In yet another alternative example, the mobile computing device 1400 is a portable phone system, such as a cellular phone. The mobile computing device 1400 may also include an optional keypad 1435. Optional keypad 1435 may be a physical keypad or a “soft” keypad generated on the touch screen display. In various examples, the output elements include the display 1405 for showing a graphical user interface (GUI), a visual indicator 1420 (e.g., a light emitting diode), and/or an audio transducer 1425 (e.g., a speaker). In some examples, the mobile computing device 1400 incorporates a vibration transducer for providing the user with tactile feedback. In yet another example, the mobile computing device 1400 incorporates input and/or output ports, such as an audio input (e.g., a microphone jack), an audio output (e.g., a headphone jack), and a video output (e.g., a HDMI port) for sending signals to or receiving signals from an external device.

FIG. 14B is a block diagram illustrating the architecture of one example of a mobile computing device. That is, the mobile computing device 1400 can incorporate a system (i.e., an architecture) 1402 to implement some examples. In examples, the system 1402 is implemented as a “smart phone” capable of running one or more applications (e.g., browser, e-mail, input processing, calendaring, contact managers, messaging clients, games, and media clients/players). In some examples, the system 1402 is integrated as a computing device, such as an integrated personal digital assistant (PDA) and wireless phone.

One or more application programs 1466 may be loaded into the memory 1462 and run on or in association with the operating system 1464. Examples of the application programs include phone dialer programs, e-mail programs, personal information management (PIM) programs, word processing programs, spreadsheet programs, Internet browser programs, messaging programs, and so forth. The system 1402 also includes a non-volatile storage area 1468 within the memory 1462. The non-volatile storage area 968 may be used to store persistent information that should not be lost if the system 1402 is powered down. The application programs 1466 may use and store information in the non-volatile storage area 1468, such as e-mail or other messages used by an e-mail application, and the like. A synchronization application (not shown) also resides on the system 1402 and is programmed to interact with a corresponding synchronization application resident on a host computer to keep the information stored in the non-volatile storage area 1468 synchronized with corresponding information stored at the host computer. As should be appreciated, other applications may be loaded into the memory 1462 and run on the mobile computing device 1400, including application 1328, IO manager 1324, and other utility 1326 described herein.

The system 1402 has a power supply 1470, which may be implemented as one or more batteries. The power supply 1470 might further include an external power source, such as an AC adapter or a powered docking cradle that supplements or recharges the batteries.

The system 1402 may include peripheral device port 1478 that performs the function of facilitating connectivity between system 1402 and one or more peripheral devices. Transmissions to and from the peripheral device port 1478 are conducted under control of the operating system 1464. In other words, communications received by the peripheral device port 1478 may be disseminated to the application programs 1466 via the operating system 1464, and vice versa.

The system 1402 may also include a radio 1472 that performs the function of transmitting and receiving radio frequency communications. The radio 1472 facilitates wireless connectivity between the system 1402 and the “outside world,” via a communications carrier or service provider. Transmissions to and from the radio 1472 are conducted under control of the operating system 1464. In other words, communications received by the radio 1472 may be disseminated to the application programs 1466 via the operating system 1464, and vice versa.

The visual indicator 1420 may be used to provide visual notifications, and/or an audio interface 1474 may be used for producing audible notifications via the audio transducer 1425. In the illustrated example, the visual indicator 1420 is a light emitting diode (LED) and the audio transducer 1425 is a speaker. These devices may be directly coupled to the power supply 1470 so that when activated, they remain on for a duration dictated by the notification mechanism even though the processor 1460 and other components might shut down for conserving battery power. The LED may be programmed to remain on indefinitely until the user takes action to indicate the powered-on status of the device. The audio interface 1474 is used to provide audible signals to and receive audible signals from the user. For example, in addition to being coupled to the audio transducer 1425, the audio interface 1474 may also be coupled to a microphone to receive audible input, such as to facilitate a telephone conversation. In accordance with examples of the present invention, the microphone may also serve as an audio sensor to facilitate control of notifications, as will be described below. The system 1402 may further include a video interface 1476 that enables an operation of an on-board camera 1430 to record still images, video stream, and the like.

A mobile computing device 1400 implementing the system 1402 may have additional features or functionality. For example, the mobile computing device 1400 may also include additional data storage devices (removable and/or non-removable) such as, magnetic disks, optical disks, or tape. Such additional storage is illustrated in FIG. 14B by the non-volatile storage area 1468.

Data/information generated or captured by the mobile computing device 1400 and stored via the system 1402 may be stored locally on the mobile computing device 1400, as described above, or the data may be stored on any number of storage media that may be accessed by the device via the radio 1472 or via a wired connection between the mobile computing device 1400 and a separate computing device associated with the mobile computing device 1400, for example, a server computer in a distributed computing network, such as the Internet. As should be appreciated such data/information may be accessed via the mobile computing device 1400 via the radio 1472 or via a distributed computing network. Similarly, such data/information may be readily transferred between computing devices for storage and use according to well-known data/information transfer and storage means, including electronic mail and collaborative data/information sharing systems.

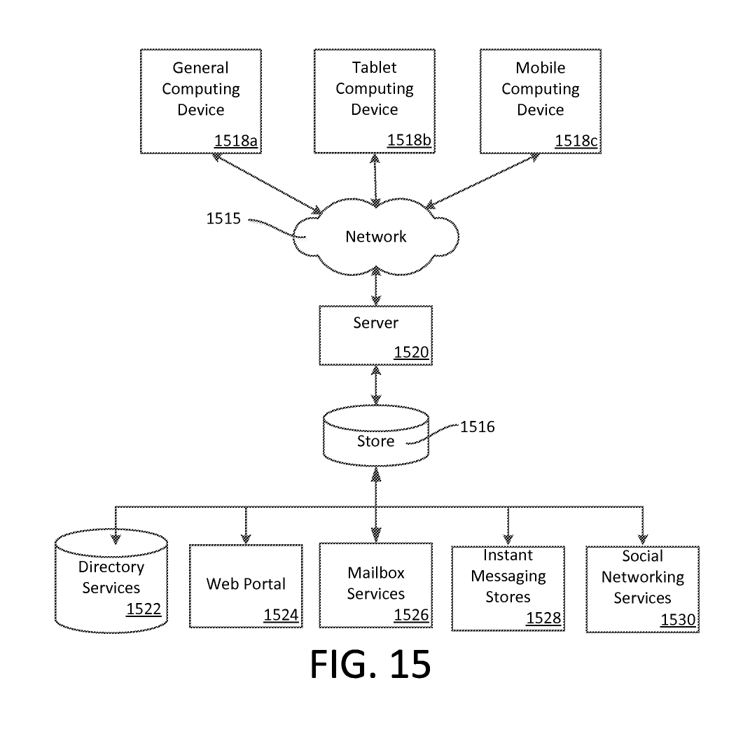

FIG. 15 illustrates one aspect of the architecture of a system for processing data received at a computing system from a remote source, such as a computing device 1504, tablet 1506, or mobile device 1508, as described above. A query transformation may be running at server device 1502 and may be stored in different communication channels or other storage types, such as data store 1516. In aspects, the general computing device 1504 is executing a digital assistant that is part of the file history system described herein. Further, in this aspect, the tablet 1506 is thin digital assistant that is part of the file history system described herein. Additionally, in this aspect, the mobile computing device 1508 is executing a spreadsheet application that is part of the file history system described herein. Systems and methods for simplifying natural language queries are described in detail above and illustrated in FIGS. 1-12. In addition, various queries may be received using a directory service 1522, a web portal 1524, a mailbox service 1526, an instant messaging store 1528, or a social networking site 1530.

Aspects of the technology include a system. The system may include at least one processor operatively coupled to at least one computer storage memory device. The device may have instructions that when executed perform a method. In aspects, the method includes receiving a natural language query. The method may also include a transformation sequence to apply to the natural language query. The transformation sequence may comprise two or more of: key concept detection, dependency filtering, stop structure removal, stop word removal, and noun/phrase entity detection. In aspects, the method also includes applying a transformation sequence to the natural language query to generate a transformed natural query. The method may additionally include sending the transformed natural language query.

Additionally, the transformation sequence may include an ordered sequence. The order sequence may be one of applying a key concept detection, applying dependency filtering, applying stop structure removal, applying stop word removal, and applying noun/phrase entity detection. Further, the transformed natural language query may be sent to an Internet search engine application.

In aspects, the method may further include, prior to determining the transformation sequence, identifying an origination of the natural language query. The determining the transformation sequence may be based on the origination of the natural language query. In aspects, the origination of the natural language query may be an Internet search engine application stored on a computing device.

In aspects, the key concept detection may apply a weight to at least a portion of the natural language query, and the weight may be used by the Internet search engine to rank results. Further, the key concept detection may identify a portion of the natural language query, and the application of the stop word removal may not affect the portion of the natural language query. These above referenced functionality may be employed as a computer method, a system, and/or a computer readable storage device.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

1. A system comprising at least one processor operatively coupled to at least one computer storage memory device, the device having instructions that when executed perform a method comprising:
receiving a natural language query;
determining a transformation sequence to apply to the natural language query, wherein the transformation sequence comprises two or more of: key concept detection, dependency filtering, stop structure removal, stop word removal, and noun/phrase entity detection,
applying a transformation sequence to the natural language query to generate a transformed natural query; and
sending the transformed natural language query.

2. The system of claim 1, wherein the transformation sequence comprises an ordered sequence of:
applying a key concept detection;
applying dependency filtering;
applying stop structure removal;
applying stop word removal; and
applying noun/phrase entity detection.

3. The system of claim 1, wherein the transformed natural language query to an Internet search engine application.

4. The system of claim 1, the method further comprising:
prior to determining the transformation sequence, identifying an origination of the natural language query; and
wherein the determining the transformation sequence is based on the origination of the natural language query.

5. The system of claim 4, wherein the origination of the natural language query is an Internet search engine application stored on a computing device.

6. The system of claim 5, wherein the key concept detection applies a weight to at least a portion of the natural language query, the weight used by the Internet search engine to rank results.

7. The system of claim 2, wherein the key concept detection identifies a portion of the natural language query, wherein the application of the stop word removal does not affect the portion of the natural language query.

8. A computer implemented method comprising:
receiving a natural language query;
determining a transformation sequence to apply to the natural language query, wherein the transformation sequence includes key concept detection, dependency filtering, stop structure removal, stop word removal, and noun/phrase entity detection;
applying a transformation sequence to the natural language query to form a transformed natural query; and
sending the transformed natural language query.

9. The method of claim 8, wherein the transformation sequence comprises an ordered sequence of applying a key concept detection;
applying dependency filtering;
applying stop structure removal;
applying stop word removal; and
applying noun/phrase entity detection.

10. The method of claim 8, wherein the transformed natural language query to an Internet search engine application.

11. The method of claim 8, further comprising:
prior to determining the transformation sequence, identifying an origination of the natural language query; and
wherein the determining the transformation sequence is based on the origination of the natural language query.

12. The method of claim 11, wherein the origination of the natural language query is an Internet search engine application stored on a user's computing device.

13. The method of claim 12, wherein the key concept detection applies a weight to at least a portion of the natural language query, the weight used by the Internet search engine to rank results.

14. The method of claim 9, wherein the key concept detection identifies a portion of the natural language query, wherein the application of the stop word removal does not affect the portion of the natural language query.

15. A computer memory storage device storing instructions that, when executed, are capable of performing a method comprising:
determining a transformation sequence to apply to the natural language query, wherein the transformation sequence includes key concept detection, dependency filtering, stop structure removal, stop word removal, and noun/phrase entity detection;
applying a transformation sequence to the natural language query to form a transformed natural query; and
sending the transformed natural language query.

16. The computer-readable storage device of claim 15, wherein the transformation sequence comprises an ordered sequence of:
applying a key concept detection;
applying dependency filtering;
applying stop structure removal;
applying stop word removal; and
applying noun/phrase entity detection.

17. The computer-readable storage device of claim 16, wherein the transformed natural language query to an Internet search engine application.

18. The computer-readable storage device of claim 16, the method further comprising:
prior to determining the transformation sequence, identifying an origination of the natural language query; and
wherein the determining the transformation sequence is based on the origination of the natural language query.

19. The computer-readable storage device of claim 18, wherein the origination of the natural language query is an Internet search engine application stored on a user's computing device.

20. The computer-readable storage device of claim 19, wherein the key concept detection applies a weight to at least a portion of the natural language query, the weight used by the Internet search engine to rank results.
